(19) United States
(12) Patent Application Publication
(10) Pub. No.: US 2005/0133586 A1
(43) Pub. Date: Jun. 23, 2005

(54) Apparatus and method for age verification of paper checks for electronic redeposit

(76) Inventors: James Rekeweg, Houston, TX (US); Cheryl Phillips, Maple Shade, NJ (US); David Smith, Sugar Land, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/744,459

(22) Filed: Dec. 22, 2003

(51) Int. Cl. G06F 17/60

(52) U.S. Cl. 235/379

(57) ABSTRACT

A verification system for electronic redeposit of paper checks determines with a merchant terminal whether a paper check meets criteria for electronic redeposit. In an embodiment of the invention, the electronic redeposit verification system verifies with a terminal that the age of the check is less than a predetermined threshold. In a further embodiment of the invention, the National Automated Clearing House Association (NACHA) establishes the threshold.

### BACKGROUND OF THE INVENTION

1. Field of the Invention

This invention relates to financial transaction processing, and, in particular, to qualifying a paper check for electronic redeposit from a merchant terminal.

2. Description of the Related Art

Many financial transactions involve a customer making a payment in exchange for goods or services from a merchant. Many times the payment is in a promissory form that instructs the customer's bank to pay the merchant. A check is one example of such promissory form of payment. The customer writes a check and presents it to the merchant as a convenient way for the customer to make a payment to the merchant. The merchant will then, typically at the end of the day, provide the check (together with others received that day) to the merchant bank as a deposit to the account, which the merchant maintains in the merchant bank.

The merchant bank, after posting the checks to the merchant account, forwards a batch of checks to the appropriate issuing banks.

As is well known, the funds promised by the check are sometimes not paid due to reasons such as insufficient or uncollected funds in the customers' checking accounts or fraud.

If there were insufficient funds or uncollected funds in the customer's account at the time that the check was initially processed, the merchant can collect the funds if the merchant redeposits the check when sufficient funds exist in the customer's account. The merchant can redeposit the paper check.

The amount of time to redeposit a paper check varies. It can take between 5 to 8 days before the merchant knows whether the check cleared. The merchant also has little control over when the redeposit will debit the customer's account.

### SUMMARY OF THE INVENTION

Rather than redepositing a paper check, if the check meets predetermined criteria, the merchant has the option of electronically redepositing the check. To electronically redeposit the check, the merchant, a check acceptance service, or the like creates an electronic ACH debit from the information on the paper check.

Creating an electronic ACH debit has several advantages over redepositing the paper check. An electronic ACH debit can take fewer days to process. For example, the merchant can often determine in 2-3 days whether the check cleared. It is may also be possible to influence the date the electronic ACH debit debits the customer's account. For example, paydays traditionally occur on Fridays or on the first and the fifteenth of the month. If the merchant controls when to create an ACH debit, such as just prior to the payday, then the electronic ACH debit debits the customer's account when there is a greater probability of funds in the account. Additionally, an electronic redeposit has priority over a paper check redeposit at the customer's bank, which again increases the likelihood that the customer's account will have sufficient funds to pay the check.

However, merchants have difficulty determining the criteria for electronic redeposit. Complying with the NACHA rules for electronic redeposit of paper checks can be time consuming and frustrating for merchants. If a merchant submits a check, which does not qualify for electronic redeposit, the financial institution returns the check to the merchant. This further delays the possible collection of the funds for the merchant.

In one embodiment of the invention, an electronic redeposit verification system allows a merchant, using a merchant terminal, to verify that a paper check meets certain criteria to be redeposited as an electronic ACH debit.

One such criterion is the age of the paper check. The age of the paper check is the number of days between the date the check was written and the date the check is electronically redeposited. In another embodiment, the age of the paper check is the number of days between the date the check is written and the date the ACH debit is originated. If the age of the paper check is greater than a predetermined threshold, the paper check is ineligible for electronic conversion.

In an embodiment of the invention, the merchant enters the check date into an interactive merchant terminal. The terminal retrieves the current date from its internal clock and calculates the age of the check. In another embodiment, the terminal retrieves the current date from the host. The merchant terminal compares the age of the check with the threshold. If the age of the check is less than the threshold, the merchant terminal proceeds with the electronic redeposit process. If the age of the check exceeds the threshold, the merchant terminal ends the electronic redeposit process, and, in an embodiment, the merchant terminal indicates that the check is ineligible for electronic redeposit.

One embodiment of the invention relates to a method of determining the age of a paper check for electronic redeposit. The method comprises receiving a returned paper check where the paper check is returned due to lack of funds in the payer's account. The method further comprises entering the check date into an interactive terminal, calculating the age of the check, and comparing the age of the check with a predetermined age threshold. The method also comprises qualifying the check for electronic redeposit if the age of the check does not exceed the age threshold and proceeding with the electronic redeposit. The method further comprises displaying on the interactive terminal that electronic redeposit is not allowed if the age of the check exceeds the age threshold and ending the electronic redeposit process.

In another embodiment of the invention, an apparatus for verifying the age of a check for electronic redeposit comprises an interactive terminal having an entry pad for entering a check date and a display for displaying information to a user, a clock for determining a current date, and computer readable code. The computer readable code comprises instructions to calculate the age of the check from the check data and the current date, to compare the age of the check with a predetermined threshold, and to display information to the user if the age of the check exceeds the predetermined age threshold.

In another embodiment of the invention, an article of manufacture comprises a computer readable medium having computer readable code. The computer readable code responds to commands to read the check date, to retrieve the current date and to calculate the age of the check from the check date and the current date. The computer code further responds to commands to compare the age of the check with a predetermined age threshold. If the age of the check does not exceed the predetermined age threshold, the computer code responds to a command to proceed with the electronic redeposit process. If the age of the check exceeds the predetermined age threshold, the computer readable code responds to a command to end the electronic redeposit process, and to display on the terminal that electronic redeposit is not allowed.

In an embodiment, the merchant starts an automatic redeposit process by entering a code, pushing a key on the merchant terminal, or swiping the check through the MICR reader. The redeposit process automatically verifies the check amount and the check age, contacts the host computer so as to allow the host computer to verify any additional criteria for electronic redeposit, and initiates through the host computer the ACH debit process. In addition to starting the turn key qualification process, the merchant only takes action in response to queries or commands from the terminal displayed on the terminal display. The terminal may tell the merchant, for example, to insert check into MICR reader, or to enter the check date.

Thus, the merchant easily complies with the rules for electronic redeposit. The merchant is not frustrated by the process, and increases the possible collections of funds from returned paper checks.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 illustrates a paper check electronic redeposit system, according to an embodiment of the invention.

FIG. 2 illustrates a merchant terminal, according to an embodiment of the invention.

FIG. 3 is a flow diagram of operations performed by a process to qualify a paper check for electronic redeposit, according to an embodiment of the invention.

FIG. 4 is a flow diagram of operations performed to determine whether the amount of a returned paper check qualifies the paper check for electronic redeposit, according to an embodiment of the invention.

FIG. 5 is a flow diagram of operations performed to determine whether the age of a returned paper check qualifies the paper check for electronic redeposit, according to an embodiment of the invention.

FIG. 6 is a flow diagram of operations performed by a host system to determine if a returned paper check qualifies for electronic redeposit, according to an embodiment of the invention.

FIG. 7 is a flow diagram of operations performed by a check image processing process, according to an embodiment of the invention.

### DETAILED DESCRIPTION OF THE PREFERRED EMBODIMENTS

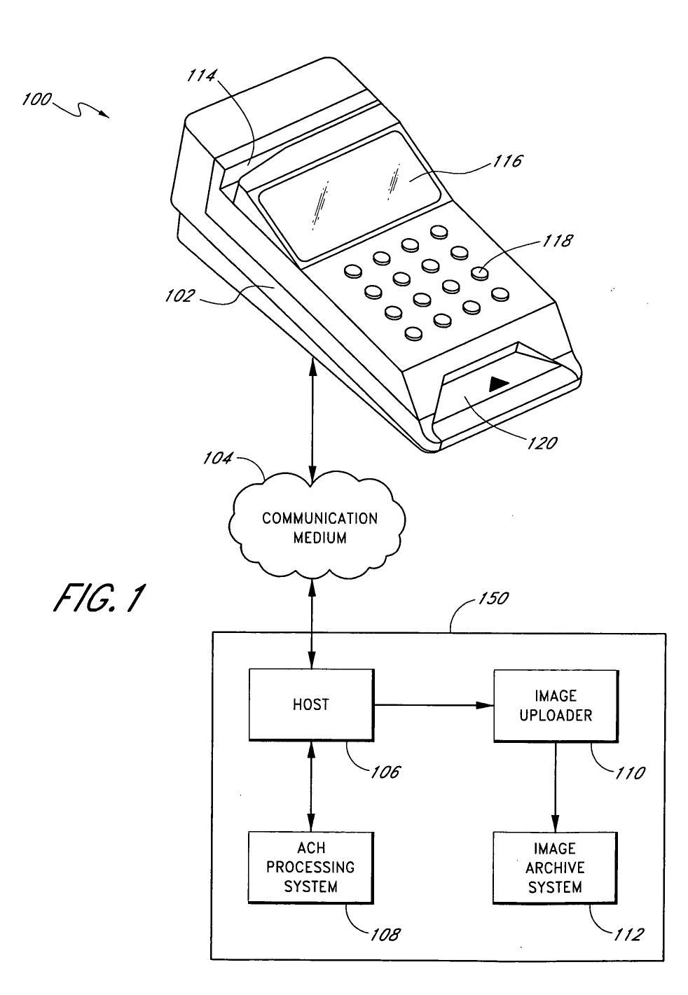

An electronic redeposit verification system determines with a merchant terminal whether a paper check meets certain criteria to qualify for electronic redeposit. For a more detailed understanding of the invention, reference is first made to FIG. 1. FIG. 1 depicts an embodiment of a verification system for electronic redeposit of paper checks 100. The verification system for electronic redeposit of paper checks 100 comprises an interactive electronic transaction terminal 102, a communications medium 104, and an electronic redeposit system 150.

As shown in FIG. 1, in an embodiment, the interactive electronic transaction terminal or merchant point of sale (POS) terminal 102 comprises a Magnetic Ink Character Recognition (MICR) reader 114, a display 116, a keypad 118, and a magnetic stripe reader 120. The MICR reader 114 includes a MICR read head positioned adjacent a MICR slot and is operative for electronically reading the MICR characters on a check. The form or font of the MICR characters and their positions along the bottom edge of the check are prescribed ANSI standards X9.27-1988 and X9.13-1990, which are published by the American National Standards Institute, Inc. 25 West 43^{rd} Street 4^{th} Floor, New York, N.Y. 10036, and are incorporated herein by reference.

In another embodiment, the MICR reader is a stand-alone unit, which communicates with the terminal through an interface.

In an embodiment, the merchant inserts the check into the MICR reader 114 on the terminal 102. The interactive terminal 102 reads the MICR line and determines whether the MICR line contains valid characters in the area corresponding to the check amount. If the MICR characters are valid, the interactive terminal 102 compares the value of the check encoded on the MICR line with a predetermined threshold. If the check amount exceeds the predetermined threshold, the paper check does not qualify for electronic redeposit. The merchant terminal 102 indicates to the merchant that electronic redeposit is not allowed by displaying a message on the terminal display 116.

In another embodiment, the merchant terminal 102 sends the MICR line data to the host 106. The host 106 determines whether the MICR line contains valid characters in the area corresponding to the check amount. If the MICR characters are valid, the host 106 compares the value of the check encoded on the MICR line with a predetermined threshold. If the check amount exceeds the predetermined threshold, the paper check does not qualify for electronic redeposit. The host 106 indicates to the merchant through the merchant terminal 102 that electronic redeposit is not allowed by displaying a message on the terminal display 116.

If the check amount encoded on the MICR line does not exceed the predetermined threshold amount, the interactive terminal 102 proceeds with the verification process.

In an embodiment, the terminal 102 prompts the merchant to enter the check date from the paper check by displaying a message on the display 116. The merchant enters the check date into the merchant terminal 102 using the keypad 118. The terminal 102 retrieves the current date from an internal clock and calculates the age of the check. The terminal compares the age of the check with a predetermined age threshold. If the age of the check exceeds the age threshold, the paper check does not qualify for electronic redeposit. The merchant terminal 102 indicates to the merchant that electronic redeposit is not allowed by displaying a message on the terminal display 116.

In another embodiment, the merchant retrieves the current date from the host 106. In a further embodiment, the terminal 102 sends the check date data to the host 106 and the host 106 calculates the age of the check. The host 106 further compares the age of the check with the predetermined threshold. If the age of the check exceeds the age threshold, the paper check does not qualify for electronic redeposit. The host 106 indicates to the merchant through the merchant terminal 102 that electronic redeposit is not allowed by displaying a message on the terminal display 116.

If the age of the check does not exceed the predetermined threshold age, the interactive terminal 102 proceeds with the verification process.

The interactive electronic transaction terminal or POS terminal 102 transmits information from the paper check through the communication medium 104 to the electronic redeposit system 150. The electronic redeposit system 150 verifies that the returned paper check meets additional criteria for electronic redeposit using the transmitted information. For example, in an embodiment, checks drawn on some credit unions are not available for electronic redeposit. In addition, in an embodiment, business checks are not available for electronic redeposit. In another embodiment, stolen checks, forged checks, checks having a stop payment, checks with an invalid account number, checks with an unknown account number, or the like, are not available for electronic redeposit. In an embodiment, the additional criteria comprises whether the check is returned due to uncollected funds or insufficient funds. Typically, a database in the electronic redeposit system 150 stores the additional criteria.

Focusing now on the communication medium 104, in one embodiment of the invention, the communications medium 104 is a telephone network. In other embodiments, the communications medium 104 can be any communication system including by way of example, dedicated communication lines, the Internet, which is a global network of computers, wireless data transmission systems, two-way cable systems, customized computer networks, interactive kiosk networks, automatic teller machine networks, interactive television networks, and the like.

The electronic redeposit system 150 receives the check information from the interactive terminal 102 and determines whether the paper check qualifies for electronic redeposit based on additional criteria as described above.

The electronic redeposit system 150 comprises a host computer 106, an ACH debit processing system 108, an image uploader 110, and an image archive system 112.

The host computer 106 can be associated with a merchant, a check processing company, a check acceptance service, or the like. Some merchants employ check processing companies, such as, for example, TeleCheck Inc., or the like, to handle their checking transaction processing.

In one embodiment, after the merchant terminal 102 verifies that the paper check qualifies for electronic redeposit based on the check age and the check amount, the host computer 106 receives the check information from the merchant terminal 102. The check information comprises, for example, information from a MICR line and check image data.

The host computer 106 further comprises a database, which comprises additional qualification criteria, such as, for example, financial institutions that do not permit electronic redeposit of paper checks. If the check does not qualify for electronic redeposit, the host computer 106 transmits a message denying electronic redeposit of the paper check to the merchant terminal 102. In an embodiment, the merchant terminal displays a message to the user stating that electronic redeposit is denied.

If the paper check qualifies for electronic redeposit, the host computer 106 creates an ACH debit request for the paper check from the information. The host computer 106 transmits the ACH debit request to the ACH debit processing system 108 to initiate processing of the ACH debit. Additionally, once a check is approved for electronic redeposit by the verification system 100, the host computer 106 communicates with the image archiving device 112 via the image uploader 110 to store a full image or at least a portion of a check image. In an embodiment of the invention, the image uploader 110 transmits check image data to the archival storage system 112. In an embodiment of the invention, the archival storage system 112 stores the check image according to NACHA's rules for electronic redeposit.

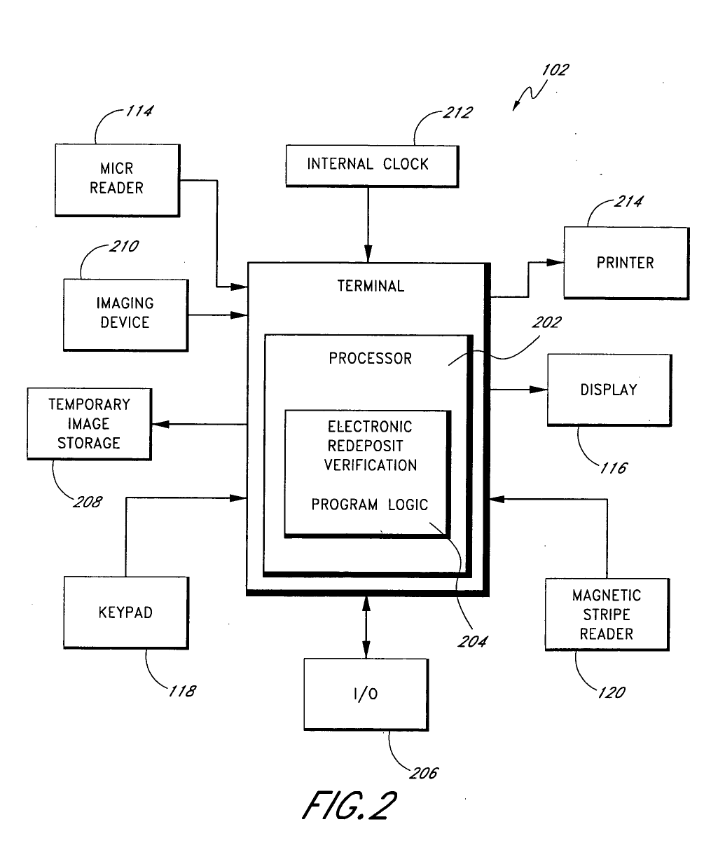

FIG. 2 illustrates functional blocks of an embodiment of the merchant terminal 102. The merchant terminal 102 comprises a computer 202, which further comprises electronic redeposit verification program logic 204.

The computer 202 can comprise, by way of example, processors, program logic, or other substrate configurations representing data and instructions, which operate as described herein. In other embodiments, the processors can comprise controller circuitry, processor circuitry, processors, general purpose single-chip or multi-chip microprocessors, digital signal processors, embedded microprocessors, microcontrollers and the like.

In one embodiment of the invention, the program logic 204 can advantageously be implemented as one or more modules. The modules can advantageously be configured to execute on one or more processors. The modules can comprise, but are not limited to, any of the following: software or hardware components such as software object-oriented software components, class components and task components, processes, methods, functions, attributes, procedures, subroutines, segments of program code, drivers, firmware, microcode, circuitry, data, databases, data structures, tables, arrays, or variables.

In another embodiment, the processor 202 and the program logic 204 resides in the host 106.

As illustrated in FIG. 2, the merchant terminal 102 further comprises an input/output port 206, a temporary image storage buffer 208, an imaging device 210, an internal clock 212, a printer 214, the MICR reader 114, the display 116, the keypad 118, and the magnetic stripe reader 120.

In an embodiment of the invention, the merchant receives a check, which is returned, for example, due to lack of funds, insufficient funds, unavailable funds, or the like in the payer's checking account. The merchant inserts the returned check into the MICR reader 114 of the merchant terminal 102. The MICR reader 114 reads the MICR line. In another embodiment, the merchant manually enters the characters on the MICR line using the keypad 118.

The MICR line comprises characters formed of magnetic ink, which include, for example, a transit number, a bank number, and an account number. In addition, the merchant bank encodes the check amount on the MICR line when the paper check is initially processed.

The merchant terminal 102 determines whether the MICR line is encoded with a check amount. If the check has a blank or null check amount on the MICR line, then the check has not been initially processed. In an embodiment, paper, checks that have not been processed are not eligible for electronic redeposit. In an embodiment, the terminal 102 displays on display 116 that electronic redeposit of the check is denied.

Further, the terminal 102 determines whether the check amount encoded on the MICR line is greater than a predetermined amount threshold. When the check amount is greater than the predetermined amount, the terminal 102 displays on display 116 that electronic redeposit of the check is denied. When the check amount is not greater than the predetermined amount threshold, the verification process for electronic redeposit of paper checks proceeds. In an embodiment, the process proceeds automatically.

In another embodiment, the host 106 determines whether the MICR line is encoded with a check amount and the host 106 determines whether the check amount encoded on the MICR line is greater than a predetermined threshold.

In another embodiment of the invention, the merchant enters the check date into the merchant terminal 102 using the keypad 118. The merchant terminal 102 retrieves the current date from its internal clock 212 and calculates the age of the check. The terminal 102 compares the age of the check with a predetermined age threshold. If the age of the check is greater than the predetermined age threshold, the check is not available for electronic redeposit. The terminal 102 displays on display 116 that electronic redeposit of the check is not allowed. If the age of the check is not greater than the predetermined age threshold, the process for electronic redeposit of paper checks proceeds. In an embodiment, the process proceeds automatically.

In an embodiment, the imaging device 210 optically scans at least a portion of the check. Typically, the imaging device 210 scans the check at the same time the MICR reader reads the MICR line. The merchant terminal 102 stores the check image data in the temporary image storage buffer 208.

In a further embodiment, the imaging device 210 optically scans at least the check date. The merchant terminal 102 reads the check date by performing optical character recognition on the scanned check image data.

In an embodiment of the invention, the merchant terminal 102 automatically proceeds to electronically redeposit a paper check where the age of the check is less than the age threshold and the amount of the check is less than the amount threshold. The merchant terminal 102 contacts the host computer 106 and transmits check information, such as, for example, MICR line data and check image data, to the host computer 106. MICR line data comprises, for example, the account number, the transit number, the routing number, the check number, and the check amount. After receiving the check information, the host computer 106 determines whether the check meets additional criteria for electronic redeposit.

For example, some credit unions may not allow electronic redeposit of paper checks drawn on the credit union. In another example, NACHA rules may not allow electronic redeposit of paper business checks. In another embodiment, for example, business checks, stolen checks, forged checks, checks having a stop payment, checks with an invalid account number, checks with an unknown account number, or the like, are not available for electronic redeposit. In an embodiment, additional criteria comprises whether the check is returned for insufficient funds or uncollected funds.

Typically, the host computer 106 stores the additional criteria for electronic deposit and applies the rules to the transmitted check information. Thus, in an embodiment, the host computer 106 compares the bank numbers with a list of bank numbers of financial institutions that do not permit electronic redeposit. In another embodiment, the host computer 106 determines if the account number is a business account that does not permit electronic redeposit.

If the check meets the additional criteria for electronic redeposit, the host computer 106 sends the merchant terminal 102 an image tag and image tag instructions. The host computer 106 proceeds with the ACH debit process. The merchant terminal 102 tags, as instructed by the host computer 106, at least a portion of the check image stored in the temporary image storage buffer 208 with the image tag from the host computer 106.

In an embodiment of the invention, the host computer 106 sends the terminal 102 a report, which is printed by the printer 214. The report provides the merchant with a record of the checks, which meet the criteria for electronic redeposit. In an embodiment, the printer is an integral part of the merchant terminal 102. In another embodiment, the printer 214 is a stand-alone printer, which communicates with the merchant terminal 102 through an interface.

In an embodiment of the invention, during idle time, the merchant terminal 102 uploads the tagged images that have been stored in the merchant terminal 102 for greater than a predetermined time. In another embodiment of the invention, during idle time, the merchant terminal 102 uploads the tagged images when the accumulated tagged image size exceeds a predetermined memory amount. The terminal 102 uploads the tagged images to the host computer 106 and the host computer 106 sends the tagged images to the image archival system 112 via the image uploader 110.

If the check does not meet the additional criteria for electronic redeposit, the host computer 106 transmits a message to the merchant terminal 102. In an embodiment, the merchant terminal 102 displays on display 116 that electronic redeposit of the check is denied.

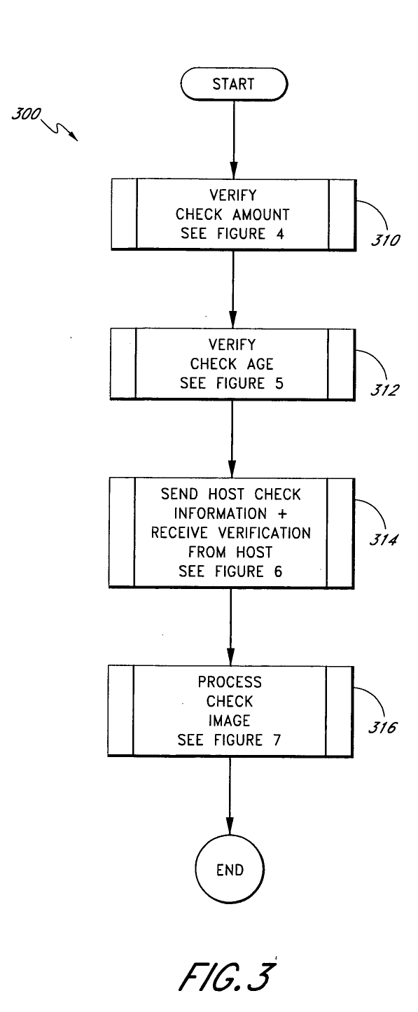

FIG. 3 is a flow diagram of operations performed by a process to qualify a paper check for electronic redeposit, according to an embodiment of the invention.

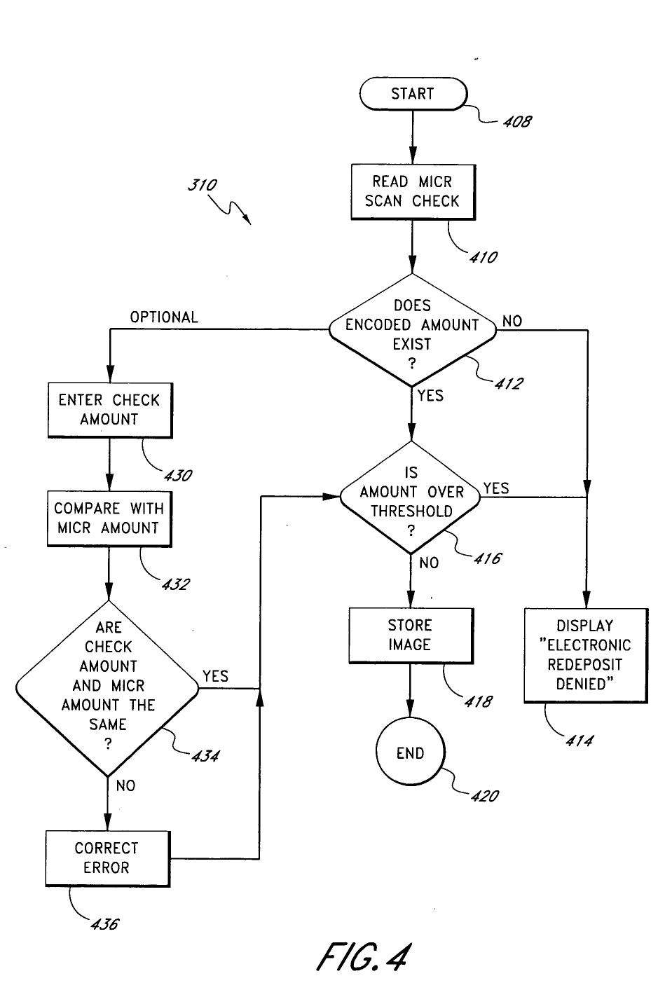

In block 310, the merchant terminal 102 verifies that the MICR line of the check comprises a valid check amount and that the check amount is less than a predetermined amount threshold. The terminal 102 reads the MICR line and compares the encoded value of the check with a predetermined amount threshold. FIG. 4 describes the process in further detail.

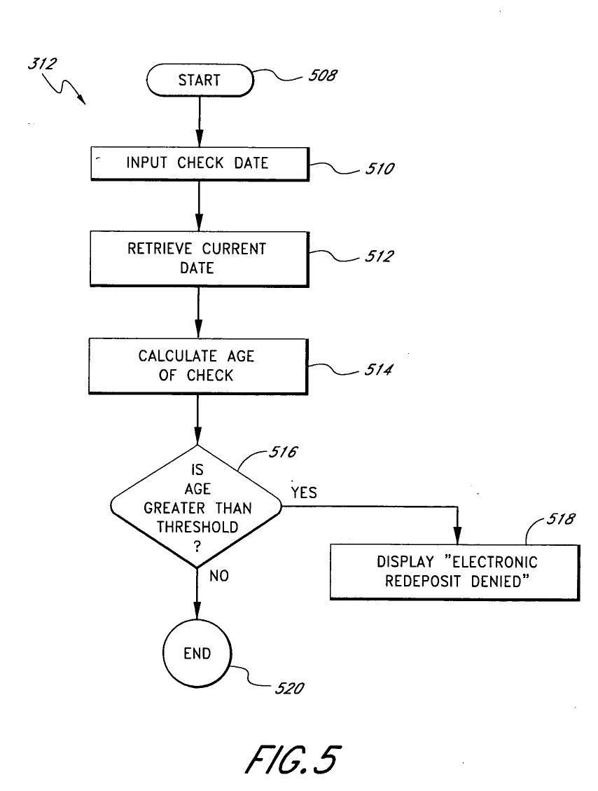

In block 312, the merchant terminal 102 verifies that the age of the check is less than a predetermined age threshold. The merchant enters the check date into the merchant terminal 102. The terminal 102 retrieves the current date from the internal clock 212, and calculates the age of the check. In an embodiment, the terminal 102 subtracts the check date from the current date to generate the age of the check. The terminal 102 compares the age of the check with a predetermined age threshold. FIG. 5 describes the process in further detail.

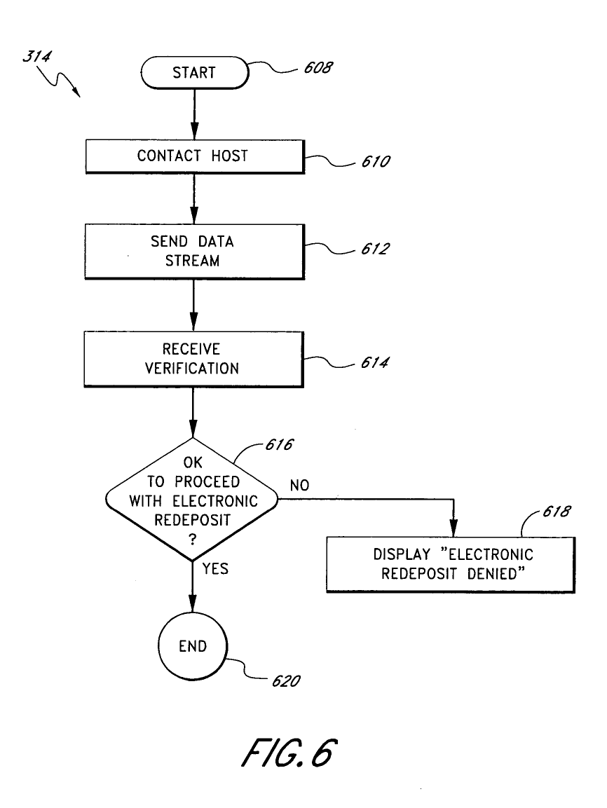

In block 314, the merchant terminal 102 sends to the host computer 106 the check information, such as, for example, the account number, the check number, the transit number, and the routing number, and receives notification from the host computer 106 whether the check meets additional criteria for electronic redeposit. The host computer stores additional criteria, such as, for example, financial institutions that do not permit checks drawn on their accounts to be electronically redeposited, and compares the additional criteria with the transmitted check information. The host computer 106 also sends the merchant terminal 102 the image tag for the check image data if the check qualifies for electronic redeposit. FIG. 6 describes the process in further detail.

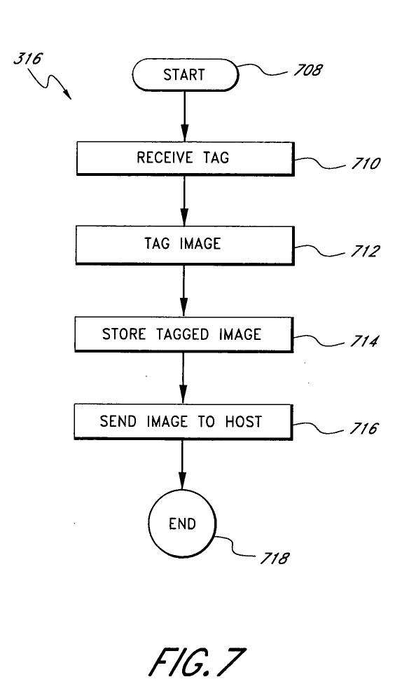

In block 316, the merchant terminal 102 tags at least a portion of the check image with the image tag and stores the tagged check image. The merchant terminal 102 transmits tagged check image data to the host computer 106 during idle time. FIG. 7 describes the process in further detail.

FIG. 4 illustrates in more detail the process of block 310. The merchant receives a check, which is returned, for example, due to insufficient or unavailable funds in the payer's checking account. In an embodiment of the invention, the merchant indicates the start of a redeposit process by keying a code on the terminal keypad 118. In an embodiment of the invention, the merchant inserts the check into the MICR reader 114 of the merchant terminal 102. The check amount verification process begins at a start block 408.

In block 410, the merchant terminal 102 reads the MICR encoded line on the check and scans all or a portion of the check. The merchant terminal 102 temporarily stores all or a portion of the check as check image data in the temporary image storage 208.

In block 412, the merchant terminal 102 determines whether an encoded check amount exists on the MICR line. The merchant bank encodes and applies the check amount to the MICR line during the initial deposit process. It is likely that a check without an encoded check amount on the MICR line is not a returned or bounced check and can not be electronically redeposited in accordance with an embodiment of the invention.

In block 414, for checks without an encoded check amount on the MICR line, the terminal 102 displays to the merchant that electronic redeposit is denied. In an embodiment, the terminal 102 displays to the merchant that the check amount on the MICR line is not detected. In another embodiment, the terminal 102 displays to the merchant that the merchant should deposit the paper check.

Optionally, in an embodiment of the invention, the merchant can verify that the MICR line contains a dollar-encoded amount by visually inspecting the MICR line before inserting the check into the MICR reader 114.

For checks with a valid check amount on the MICR line in block 412, the process moves to block 416 or optionally, block 430.

In an optional embodiment, the merchant terminal 102 can compare the MICR encoded check amount with a merchant entered check amount.

In another optional embodiment, the merchant terminal 102 can correct errors in the MICR encoded check amount.

In block 430, the merchant enters the check amount into the merchant terminal 102 using the keypad 118.

In block 432, the merchant terminal 102 compares the manually entered check amount with the check amount encoded on the MICR line.

In block 434, the merchant terminal 102 determines whether the manually entered check amount is the same as the check amount encoded on the MICR line. If the two amounts are the same, the check amount verification process moves to block 416.

If the manually entered check amount is not the same as the MICR dollar-encoded amount, the terminal displays to the merchant that the encoded check amount is different than the manually entered check amount.

Optionally, the merchant can correct the error in block 436. In an embodiment, the ability to override a MICR encoded-dollar amount is password protected to reduce the possibility of fraudulently changing the check amount. In an embodiment, the merchant enters a code to override the MICR line check amount to match that of the manually entered check amount. In another embodiment, the merchant reenters the check amount to override the MICR line check amount. In a further embodiment, the merchant cannot override the MICR line check amount to match that of the manually entered check amount if the manually entered check amount is greater than the predetermined threshold.

Once the merchant corrects the MICR encoded check amount, the process moves to block 416.

In block 416, the merchant terminal 102 compares the amount of the check with a predetermined amount threshold. In an embodiment, the threshold is downloaded into the merchant terminal from the host computer 106. In another embodiment, the merchant enters the threshold into the merchant terminal 102 via the keypad 118. The merchant terminal 102 stores the predetermined amount threshold in memory associated with the processor 202.

In an embodiment of the invention, the National Automated Clearing House Association (NACHA) establishes the predetermined amount threshold. In an embodiment of the invention, the predetermined amount threshold is approximately $25,000. In another embodiment of the invention, the merchant or the financial transaction processing company establishes the predetermined amount threshold. In another embodiment of the invention, the merchant or financial transaction company establishes the predetermined threshold amount, which does not exceed the predetermined threshold amount established by NACHA.

If the check amount is greater than the amount threshold, the process moves to block 414. In block 414, the merchant terminal 102 displays to the merchant that electronic redeposit is denied. In an embodiment, the merchant terminal 102 displays to the merchant that the check amount exceeds the amount permitted for electronic redeposit.

If the check amount is less than the amount threshold, the check amount verification process moves to block 418. In block 418, the image storage buffer 208 temporarily stores the check image data. In an embodiment, the check image data comprises digitally encoded optical scans of at least a portion of the check. In another embodiment, the merchant enters information, such as, for example, the account name, account address, payer's phone number, payer's drivers license number, and the like, from the check via the keypad 118.

The check amount qualification process stops at an end block. Based on the amount of the check, the returned paper check qualifies for electronic redeposit.

FIG. 5 illustrates a flow diagram of a check age verification process according to an embodiment of the invention. FIG. 5 illustrates in more detail the process of block 312. The check age verification process begins at a start block 508.

In block 510, the merchant enters a check date from the paper check into the merchant terminal 102 using the keypad 118. In an embodiment, the check date is the date the payer wrote the check.

In block 512, the merchant terminal 102 retrieves the current date and time from the internal clock 212.

In block 514, the merchant terminal 102 calculates the age of the check using the check date and the current date and time. In an embodiment, the age of the check is the number of days from the date payer wrote the check to the current date. In another embodiment, the age of the check is the number of days from the date the payer wrote the check to the date of the electronic redeposit.

In block 516, the merchant terminal 102 compares the age of the check with a predetermined age threshold. In an embodiment, the threshold is downloaded into the merchant terminal from the host computer 106. In another embodiment, the merchant enters the threshold into the merchant terminal 102 via the keypad 118. The merchant terminal 102 stores the predetermined age threshold in memory associated with the processor 202.

In an embodiment of the invention, the predetermined age threshold is 180 days. In an embodiment of the invention, the predetermined age threshold is approximately 180 days. In another embodiment of the invention, the National Automated Clearing House Association (NACHA) establishes the predetermined age threshold. In another embodiment of the invention, the merchant or the financial transaction processing company establishes the predetermined age threshold.

For checks having a check age greater than the predetermined age threshold, the check age verification process moves to block 518. Checks having a check age greater than the age threshold can not be electronically redeposited. In block 518, the merchant terminal 102 displays to the merchant that electronic redeposit is denied. In another embodiment, the merchant terminal 102 displays to the merchant that the check is too old for electronic redeposit.

For checks having a check age less than the predetermined age threshold, the check age verification process stops at an end block 520. Based on the age of the check, the returned paper check qualifies for electronic redeposit.

FIG. 6 illustrates a flow diagram of one embodiment of a host verification process. FIG. 6 illustrates in more detail the process of block 314. The host verification process begins at a start block 608.

In block 610, the merchant terminal 102 contacts the host computer 106 through the communications medium 104.

In block 612, after the host computer 106 authorizes the electronic conversion, the merchant terminal 102 transmits the check information to the host computer 106. Typically, the check information comprises information from the MICR line, such as, for example, the account number, the check number, the transit number, the routing number, and the like.

The host computer 106 verifies whether the check meets additional criteria for electronic redeposit. For example, some credit unions may not allow checks drawn on the credit union to be electronically redeposited. In another embodiment, for example, NACHA rules do not permit business checks to be electronically redeposited. In block 614, the merchant terminal receives notification from the host computer 106 as to whether the check meets any additional criteria for electronic redeposit.

In block 616, the merchant terminal 102 determines from the notification sent from the host computer 106 whether the check meets the additional criteria.

For checks not meeting the additional criteria, the process moves to block 618. In block 618, in an embodiment, the merchant terminal 102 displays to the merchant that electronic redeposit is denied.

For checks meeting any additional criteria for electronic redeposit, the host verification process stops at an end block 620. Based on any additional criteria from the host computer 106, the returned paper check qualifies for electronic redeposit. The host computer 106 proceeds with the ACH debit process.

FIG. 7 illustrates a flow diagram of a check image storage process according to an embodiment of the invention. FIG. 7 illustrates, in more detail, the process of block 316. In an embodiment, the image archival system 112 stores the check image for redeposited paper checks, according to the NACHA rules. The check image storage process begins at a start block 708.

In block 710, the merchant terminal 102 receives an image tag from the host computer 106. In an embodiment of the invention, the image tag is a 22-digit trace identifier.

In block 712, the merchant terminal tags all or a portion of the check image, as requested by the host computer 106, with the image tag.

In block 714, the merchant terminal 102 stores all or a portion of the tagged image in the temporary image storage buffer 208.

In block 716, the merchant terminal transmits the tagged images to the host computer 106. In an embodiment of the invention, the merchant terminal 102 transmits the tagged images during idle time when the age of the tagged images exceeds a predetermined amount of time. In another embodiment of the invention, the merchant terminal 102 transmits the tagged images during idle time when the accumulated size of the tagged images in the temporary image storage buffer 208 exceeds a predetermined size. The host computer 106 transmits the tagged check images to the image archive system 112 via the image uploader 110. The check image storage process stops at an end block 718.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A method of performing an electronic redeposit comprising:
calculating an age of a returned check;
comparing the age of the check with a predetermined age threshold to determine whether the age of the check exceeds the predetermined age threshold; and
automatically proceeding with an electronic redeposit transaction if the age of the check does not exceed the predetermined age threshold.

2. The method of claim 1 further comprising:
determining whether the check meets an additional criterion for the electronic redeposit transaction; and
displaying on the terminal that electronic redeposit is not allowed if the check fails to meet the additional criterion.

3. The method of claim 2 further comprising ending the electronic redeposit transaction if the check fails to meet the additional criterion.

4. The method of claim 2 wherein the additional criterion is whether a check amount exceeds a predetermined check amount threshold.

5. The method of claim 2 wherein the additional criterion is whether the check was returned for insufficient funds.

6. The method of claim 2 wherein the additional criterion is whether the check has a valid account number.

7. The method of claim 2 wherein the additional criterion is whether the check was drawn upon an institution which permits electronic redeposit of returned paper checks.

8. The method of claim 2 wherein the additional criterion is whether the check is a personal check.

9. A method of determining an age of a paper check for electronic redeposit, the method comprising: comparing with a processor an age of a paper check with a predetermined age threshold for electronic redeposit.

10. The method of claim 9 wherein the predetermined age threshold is approximately 180 days.

11. The method of claim 9 wherein the predetermined age threshold is determined by NACHA.

12. The method of claim 9 wherein the predetermined age threshold is determined by a merchant.

13. The method of claim 9 wherein the paper check is returned due to lack of funds in a payer's account.

14. The method of claim 9 wherein a terminal comprises the processor.

15. The method of claim 9 wherein a host comprises the processor.

16. A method of determining an age of a paper check for electronic redeposit, the method comprising:
comparing with a terminal an age of a check with a predetermined age threshold; and
displaying on the terminal that an electronic redeposit is not allowed if the age of the check exceeds the predetermined age threshold.

17. The method of claim 16 wherein the terminal is a merchant point of sale (POS) terminal.

18. The method of claim 16 wherein the terminal is an interactive terminal.

19. The method of claim 16 further comprising:
retrieving a current date from the terminal; and
subtracting a check date from the current date to calculate the age of the check.

20. A method of determining an age of a paper check for electronic redeposit, the method comprising:
receiving a returned paper check, wherein the paper check is returned due to lack of funds in a payer's account;
entering a check date into an interactive terminal;
retrieving a current date from the interactive terminal;
calculating an age for the check using the check date and the current date;
comparing the age of the check with a predetermined age threshold;
qualifying the check for electronic redeposit if the age of the check does not exceed the predetermined age threshold and proceeding with an electronic redeposit process; and
displaying on the interactive terminal that electronic redeposit is not allowed if the age of the check exceeds the predetermined age threshold.

21. The method of claim 20 further comprising ending the electronic redeposit process if the age of the check exceeds the predetermined age threshold.

22. The method of claim 20 wherein the interactive terminal is a merchant point of sale (POS) terminal.

23. The method of claim 20 wherein entering the check date comprises a user manually entering the check date through a keypad associated with the interactive terminal.

24. The method of claim 20 wherein entering the check date comprises scanning the check and reading magnetic indicia from the scanned check.

25. The method of claim 20 wherein entering the check date comprises optically scanning the check and performing optical character recognition (OCR) on a scanned check date.

26. An apparatus for verifying a check age for electronic redeposit of a returned paper check, the apparatus comprising:
an interactive terminal comprising an entry pad for entering a check date and a display for displaying information to a user;
a clock for determining a current date; and
computer readable code comprising instructions to calculate a check age from the check date and the current date, to compare the check age with a predetermined threshold and to display information to the user if the check age exceeds the predetermined threshold for electronic redeposit.

27. The apparatus of claim 26 wherein the interactive terminal displays a user selectable option for initiating electronic redeposit.

28. The apparatus of claim 26 wherein the interactive terminal displays that the check is too old for electronic redeposit if the check age exceeds the predetermined threshold for electronic redeposit.

29. The apparatus of claim 26 wherein the interactive terminal displays that electronic redeposit has been curtailed if the check age exceeds the predetermined threshold for electronic redeposit.

30. An apparatus for verifying a check age for electronic redeposit of a returned paper check, the apparatus comprising:
an interactive terminal comprising a display for displaying information to a user;
a clock for determining a current date; and
computer readable code comprising instructions to calculate a check age from a check date and the current date, to compare the check age with a predetermined threshold, and to automatically proceed with an electronic redeposit of the check if the check age does not exceed the predetermined threshold for electronic redeposit.

31. The apparatus of claim 30 further comprising an entry pad for entering the check date.

32. The apparatus of claim 30 wherein the interactive terminal displays that electronic redeposit is in progress if the check age does not exceed the predetermined threshold for electronic redeposit.

33. The apparatus of claim 30 wherein the instructions to calculate the check age comprise instructions to subtract the check date from the current date.

34. An article of manufacture comprising a computer readable medium having a computer readable code embodied therein for displaying check verification information for electronic redeposit on a display, the computer readable code in the article of manufacture comprising:
computer readable code responsive to a command to retrieve a current date from an interactive terminal;
computer readable code responsive to a command to calculate an age of a check using a check data and the current date;
computer readable code responsive to a command to compare the age of the check with a predetermined age threshold;
computer readable code responsive to a command to proceed with an electronic redeposit process if the age of the check does not exceed the predetermined age threshold; and
computer readable code responsive to a command to end the electronic redeposit process if the age of the check exceeds the predetermined age threshold.

35. The article of manufacture of claim 34 further comprising computer readable code responsive to a command to read the check date entered into the interactive terminal.

36. The article of manufacture of claim 34 further comprising computer readable code responsive to a command to display on the interactive terminal that electronic redeposit is not allowed if the age of the check exceeds the predetermined age threshold.

37. The article of manufacture of claim 34 wherein the predetermined age threshold is approximately 180 days.

38. The article of manufacture of claim 34 wherein the predetermined age threshold is determined by NACHA.

39. The article of manufacture of claim 34 wherein the predetermined age threshold is determined by a user.

40. The article of manufacture of claim 34 wherein calculating the age of the check comprises subtracting the check date from the current date.

41. An apparatus for determining an age of a paper check for electronic redeposit, the apparatus comprising: means for comparing with a terminal an age of a paper check with a predetermined age threshold for electronic redeposit.

42. The apparatus of claim 41 further comprising means for proceeding with an electronic redeposit process if the age of the paper check does not exceed the predetermined age threshold.

43. The apparatus of claim 41 further comprising means for ending an electronic redeposit process if the age of the paper check exceeds the predetermined age threshold.

44. An apparatus for verifying an age of a check for electronic redeposit of a returned paper check, the apparatus comprising:
means for retrieving a current date from an interactive terminal;
means for calculating an age of a check using data about the check and the current date;
means for comparing the age of the check with a predetermined age threshold;
means for proceeding with an electronic redeposit process if the age of the check does not exceed the predetermined age threshold; and
means for ending the electronic redeposit process if the age of the check exceeds the predetermined age threshold.

45. The apparatus of claim 44 further comprising means for reading a0 check date entered into the interactive terminal.

46. The apparatus of claim 44 further comprising means for displaying on the interactive terminal that electronic redeposit is not allowed if the age of the check exceeds the predetermined age threshold.

47. The apparatus of claim 44 wherein the means for reading is an optical scanner.

48. The apparatus of claim 44 wherein the means for reading reads magnetic indicia from the check.

49. The apparatus of claim 44 further comprising means for manually entering a check date into the interactive terminal.
